(19) United States
(12) Patent Application Publication
(10) Pub. No.: US 2016/0272035 A1
(43) Pub. Date: Sep. 22, 2016

(54) VEHICLE HEIGHT ADJUSTMENT APPARATUS

(71) Applicant: AISIN SEIKI KABUSHIKI KAISHA, Kariya-shi (JP)

(72) Inventors: Masaaki Oishi, Takahama-shi (JP); Yasuaki Nakaya, Miyoshi-shi (JP); Akira Kato, Anjo-shi (JP)

(73) Assignee: AISIN SEIKI KABUSHIKI KAISHA, Kariya-shi (JP)

(21) Appl. No.: 15/064,945

(22) Filed: Mar. 9, 2016

(30) Foreign Application Priority Data
Mar. 20, 2015 (JP) 2015-058156

(51) Int. Cl. B60G 17/052; B60G 17/04

(52) U.S. Cl. CPC B60G 17/0525; B60G 17/0408; B60G 2202/152; B60G 2202/42; B60G 2500/30; B60G 2600/20

(57) ABSTRACT

A vehicle height adjustment apparatus includes:f vehicle height adjustment units that are respectively provided to correspond to wheels of a vehicle body, and change a vehicle height according to supply and discharge of a working fluid; a supply source of the working fluid; opening and closing valves interposed between the vehicle height adjustment units and the supply source; and a control unit configured to control the vehicle height adjustment units so as to change the vehicle height to either one of a first vehicle height or a second vehicle height different from the first vehicle height, wherein the control unit adjusts a working fluid supply and discharge state of each of the vehicle height adjustment units to a vehicle height change start state prior to changing the vehicle height from the second vehicle height to the first vehicle height.

### CROSS REFERENCE TO RELATED APPLICATIONS

This application is based on and claims priority under 35 U.S.C. §119 to Japanese Patent Application 2015-058156, filed on Mar. 20, 2015, the entire contents of which are incorporated herein by reference.

### TECHNICAL FIELD

This disclosure relates to a vehicle height adjustment apparatus.

### BACKGROUND DISCUSSION

In the related art, a vehicle may be equipped with a suspension including air springs using compressed air. A vehicle may also be equipped with a vehicle height adjustment apparatus using air springs. The vehicle height adjustment apparatus may adopt a so-called closed type air supply and discharge system. This type of vehicle height adjustment apparatus increases a vehicle height by supplying high-pressure air (working fluid) stored in a pressure tank to the air springs that change a suspension state of each wheel. The vehicle height adjustment apparatus decreases the vehicle height by discharging the high-pressure air from the air springs back to the pressure tank. JP 2002-337531A is an example of the related art.

In contrast, the suspension (vehicle) may have frictional resistance associated with upward and downward movement of the suspension. For this reason, in a case where high-pressure air is supplied and discharged between a pressure source (for example, the pressure tank) and the air spring, an actual start of a change (vehicle height change) in the air spring is delayed from a start of the supplying and discharging of the working fluid.

A vehicle equipped with a vehicle height adjustment apparatus may change the vehicle height of the vehicle when stopped so as to reduce burdens to a user boarding and alighting from the vehicle (to enable a user to easily board and alight from the vehicle), or to improve the appearance of the vehicle when parked. In this case, a delay in a start of a vehicle height change may cause a problem. For example, when a user boards a vehicle, the amount of time between when a preparation operation for boarding (for example, releasing door lock) is performed and when the user actually boards the vehicle is short. For this reason, the vehicle height change may not occur coincidently with the timing of the boarding operation. For example, the vehicle height change may not be started, even when the user starts to board the vehicle.

### SUMMARY

Thus, a need exists for a vehicle height adjustment apparatus which is not suspectable to the drawback mentioned above.

A vehicle height adjustment apparatus according to an aspect of this disclosure includes: a plurality of vehicle height adjustment units that are respectively provided to correspond to wheels of a vehicle body, and change a vehicle height according to supply and discharge of a working fluid; a supply source of the working fluid; a plurality of opening and closing valves interposed between the vehicle height adjustment units and the supply source; and a control unit configured to control the vehicle height adjustment units so as to change the vehicle height to either one of a first vehicle height or a second vehicle height different from the first vehicle height. The control unit adjusts a working fluid supply and discharge state of each of the vehicle height adjustment units to a vehicle height change start state prior to changing the vehicle height from the second vehicle height to the first vehicle height.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating the configuration of a vehicle height adjustment apparatus in an embodiment, and illustrating a state in which a working fluid does not flow;

FIG. 2 is a diagram illustrating the state of opening and closing valves and the flow of the working fluid in a case where the vehicle height adjustment apparatus in the embodiment executes vehicle height increasing control without driving a compressor;

FIG. 3 is a diagram illustrating the state of the opening and closing valves and the flow of the working fluid in a case where the vehicle height adjustment apparatus in the embodiment performs vehicle height increasing control while driving the compressor;

FIG. 4 is a diagram illustrating the state of opening and closing valves and the flow of the working fluid in a case where the vehicle height adjustment apparatus in the embodiment performs vehicle height decreasing control while driving the compressor;

FIG. 5 is a graph illustrating comparison between transition in the spring pressure of an air spring and transition in a vehicle height;

FIG. 6 is a graph illustrating a relationship between a change in the spring pressure of an air spring and a vehicle height change, and illustrating spring pressure for a first vehicle height in a case where preadjustment is executed;

FIG. 7 is a view illustrating an example of a first detection region and a second detection region in the vehicle height adjustment apparatus of the embodiment; and

FIG. 8 is a flowchart illustrating control performed by the vehicle height adjustment apparatus in the embodiment to change the first vehicle height.

### DETAILED DESCRIPTION

Hereinafter, an exemplary embodiment of this disclosure will be disclosed. The configuration of the embodiment illustrated hereinafter, and operations and results (effects) obtained by the configuration are simply given as an example. This disclosure can be realized by configurations other than the configuration disclosed in this embodiment, and various effects (including secondary effects as well) can be obtained by a basic configuration.

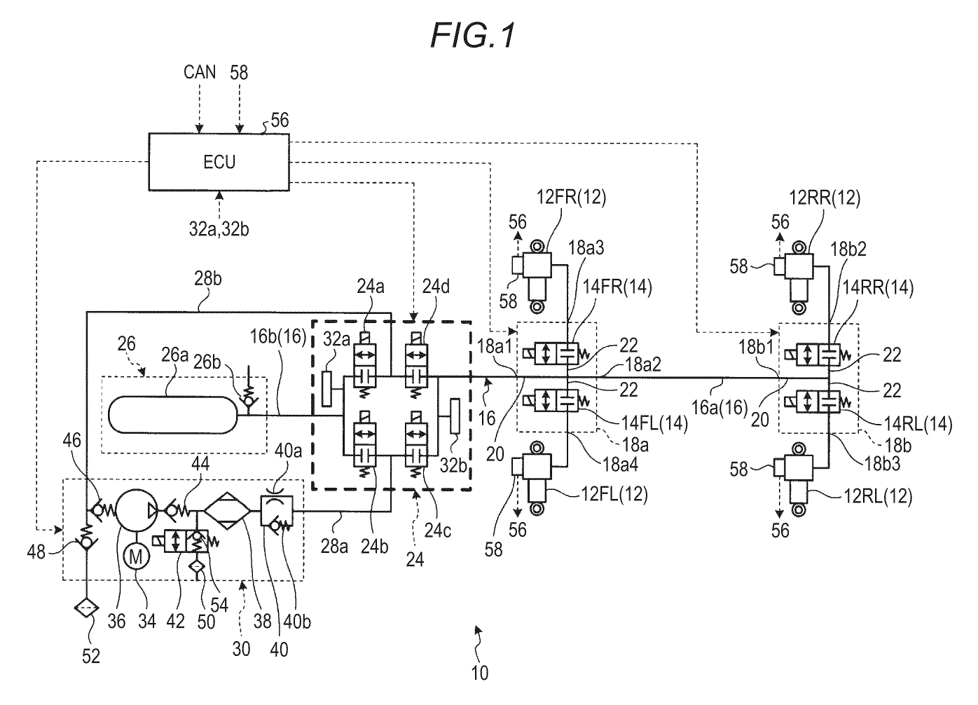

FIG. 1 is a diagram illustrating the configuration of a vehicle height adjustment apparatus 10 in the embodiment, and illustrating a state in which a working fluid does not flow.

Air springs 12FR, 12FL, 12RR, 12RL (hereinafter, also simply referred to as “air springs 12” in a case where it is not necessary to distinguish the air springs 12FR, 12FL, 12RR, 12RL from each other) serving as vehicle height adjustment units are respectively connected to the wheels of a vehicle which are not illustrated. The air spring 12 changes a suspension state of the wheel with respect to a vehicle body of the vehicle according to the supplying and discharging of the working fluid (for example, air). The air spring 12 has the function of absorbing vibration of the vehicle via the elasticity of compressed air sealed in the air spring 12. The air springs 12FR and 12FL may be referred to as front-wheel vehicle height adjustment units. The air springs 12RR and 12RL may be referred to as rear-wheel vehicle height adjustment units. A well-known structure can be used as the structure of the air spring 12. The air spring 12 easily absorbs minute vibrations compared to a metallic spring because the air spring 12 uses the elasticity of air. The vehicle height adjustment apparatus 10 can maintain a constant vehicle height, adjust the vehicle height to a desired height, or change a spring constant to a desired value by controlling air pressure.

The air springs 12FR and 12FL, which are the front-wheel vehicle height adjustment units, are connected to a main flow path 16, through which the working fluid flows, via respective vehicle height adjustment valves 14FR and 14FL. Similarly, the air springs 12RR and 12RL, which are the rear-wheel vehicle height adjustment units, are connected to the main flow path 16, through which the working fluid flows, via the respective vehicle height adjustment valves 14RR and 14RL. The vehicle height adjustment valves 14FR, 14FL, 14RR, and 14RL may be simply referred to as “vehicle height adjustment valves 14” in a case where it is not necessary to distinguish the vehicle height adjustment valves 14FR, 14FL, 14RR, and 14RL from each other. In the embodiment, the air spring 12 and the vehicle height adjustment valve 14 may be collectively referred to as a vehicle height adjustment unit.

In the embodiment, the vehicle height adjustment valves 14FR and 14FL are disposed in a flow path block made of metal or resin, while being embedded in the flow path block, and form a front wheel valve unit 18a. Similarly, the vehicle height adjustment valves 14RR and 14RL are disposed in the flow path block while being embedded in the flow path block, and form a rear wheel valve unit 18b. In another embodiment, the vehicle height adjustment valves 14 may be disposed separately from each other. In this case, the degree of freedom in the layout of the vehicle height adjustment valves 14 is improved. The four vehicle height adjustment valves 14 may be integrated into one unit. In this case, it is possible to reduce the number of components by integrating the four vehicle height adjustment valves 14 into one unit.

As illustrated in FIG. 1, the front wheel valve unit 18a and the rear wheel valve unit 18b are formed as separate units, and thus, the front wheel valve unit 18a can be disposed on a front wheel side. As a result, it is possible to reduce the length of a flow path tube from the front wheel valve unit 18a to each of the air springs 12 of the front wheels compared to a case where all of the vehicle height adjustment valves 14 are integrated into one unit. Similarly, it is possible to dispose the rear wheel valve unit 18b on a rear wheel side, and to reduce the length of a flow path tube from the rear wheel valve unit 18b to each of the air springs 12 of the rear wheels compared to a case where all of the vehicle height adjustment valves 14 are integrated into one unit. As a result, it is possible to easily route the flow path tubes, and to reduce potential risk, for example, damage to the flow path tubes due to a reduction in the length of each of the flow path tubes.

A first port 18a1 is formed in one end surface of the front wheel valve unit 18a, and is connected to the main flow path 16. A main flow path channel 20 is formed inside the front wheel valve unit 18a in such a way as to pass through the front wheel valve unit 18a, the first port 18a1 is positioned at a first end of the main flow path channel 20, and a second port 18a2 is positioned at a second end of the main flow path channel 20. Two secondary flow path channels 22 are formed inside the front wheel valve unit 18a in such a way as to branch off from the main flow path channel 20. A first end of the vehicle height adjustment valve 14FR is connected to one of the secondary flow path channels 22, and a second end of the vehicle height adjustment valve 14FR is connected to the air spring 12FR via a third port 18a3. Similarly, a first end of the vehicle height adjustment valve 14FL is connected to the other secondary flow path channel 22, and a second end of the vehicle height adjustment valve 14FL is connected to the air spring 12FL via a fourth port 18a4.

A main communication flow path 16a (the main flow path 16) is connected to the second port 18a2. The main communication flow path 16a is connected to a first port 18b1 of the rear wheel valve unit 18b. The main flow path channel 20 is formed inside the rear wheel valve unit 18b, and the first port 18b1 is positioned at a first end of the main flow path channel 20. Two secondary flow path channels 22 are also formed inside the rear wheel valve unit 18b in such a way as to branch off from the main flow path channel 20. A first end of the vehicle height adjustment valve 14RR is connected to one of the secondary flow path channels 22, and a second end of the vehicle height adjustment valve 14RR is connected to the air spring 12RR via a second port 18b2. A first end of the vehicle height adjustment valve 14RL is connected to the other secondary flow path channel 22, and a second end of the vehicle height adjustment valve 14RL is connected to the air spring 12RL via a third port 18b3.

In the example illustrated in FIG. 1, the front wheel valve unit 18a with four ports is used, and the rear wheel valve unit 18b with the three ports is used. However, for example, the same valve unit with four ports can be used on both the front wheel side and the rear wheel side. In a case where the same valve unit with four ports as the front wheel valve unit 18a is used as the rear wheel valve unit 18b, a port corresponding to the second port 18a2 is sealed with a plug cap (blind cap). In this case, it is possible to reduce the number of component types, and design costs by adopting the same type of valve units on the front wheel side and the rear wheel side.

The same type of opening and closing valves can be used as the vehicle height adjustment valves 14 (14FR, 14FL, 14RR, 14RL). For example, the vehicle height adjustment valve 14 includes an ON/OFF controlled solenoid and a spring. A normally closed electro-magnetic control valve, which is closed in a case where the solenoid of the control valve is not energized, can be used for any of the control valves.

The main flow path 16 is connected to a pressure tank 26 (supply source of the working fluid) via a circuit valve block 24 and a tank connection main flow path 16b. The circuit valve block 24 is connected to an outlet of a compressor unit 30 via a compressor outlet flow path 28a. The circuit valve block 24 is connected to an inlet of the compressor unit 30 via a compressor inlet flow path 28b. The circuit valve block 24 is formed as a valve block including multiple opening and closing valves, for example, four opening and closing valves. Specifically, the circuit valve block 24 is configured to include a first opening and closing valve 24a; a second opening and closing valve 24b; a third opening and closing valve 24c; and a fourth opening and closing valve 24d. The respective first ends of the first opening and closing valve 24a and the second opening and closing valve 24b are connected to the pressure tank 26 via the tank connection main flow path 16b (the main flow path 16). A first end of the third opening and closing valve 24c is connected to the outlet of the compressor unit 30 via the compressor outlet flow path 28a, and is connected to a second end of the second opening and closing valve 24b. A second end of the third opening and closing valve 24c is connected to the air spring 12 (the vehicle height adjustment unit, that is, the front wheel valve unit 18a). A first end of the fourth opening and closing valve 24d is connected to the inlet of the compressor unit 30 via the compressor inlet flow path 28b, and is connected to a second end of the first opening and closing valve 24a. A second end of the fourth opening and closing valve 24d is connected to the air spring 12 (the vehicle height adjustment unit, that is, the front wheel valve unit 18a).

The same type of opening and closing valves can be used as the first opening and closing valve 24a, the second opening and closing valve 24b, the third opening and closing valve 24c, and the fourth opening and closing valve 24d included in the circuit valve block 24. For example, each of the opening and closing valves includes an ON/OFF controlled solenoid, and a spring. A normally closed electro-magnetic control valve, which is closed in a case where the solenoid of the control valve is not energized, can be used for any of the control valves.

The vehicle height adjustment apparatus 10 in the embodiment includes a first pressure sensor 32a and a second pressure sensor 32b. In the example illustrated in FIG. 1, for example, the first pressure sensor 32a is disposed on the upstream side of the circuit valve block (the multiple opening and closing valves) 24. The second pressure sensor 32b is disposed on the downstream side of the circuit valve block 24. That is, the circuit valve block (valve block) 24 includes the first pressure sensor 32a for detecting the pressure of the pressure tank 26, and the second pressure sensor 32b for detecting the pressure of the air spring 12 (the vehicle height adjustment unit, that is, the front wheel valve unit 18a). For example, the circuit valve block 24 is made of metal or resin. Channels are formed inside the circuit valve block 24 so as to enable the aforementioned connection between the first opening and closing valve 24a, the second opening and closing valve 24b, the third opening and closing valve 24c, and the fourth opening and closing valve 24d. The first pressure sensor 32a is connected to one of the channels through which the first end of the first opening and closing valve 24a or the second opening and closing valve 24b is connected to the tank connection main flow path 16b (the main flow path 16) (in the example illustrated in FIG. 1, the first pressure sensor 32a is connected to a channel extending from the first end of the first opening and closing valve 24a). The second pressure sensor 32b is connected to one of the channels through which the first end of the third opening and closing valve 24c or the fourth opening and closing valve 24d is connected to the main flow path 16 (in the example illustrated in FIG. 1, the second pressure sensor 32b is connected to a channel extending from the first end of the third opening and closing valve 24c).

For example, in a case where the first opening and closing valve 24a and the second opening and closing valve 24b are closed, the first pressure sensor 32a is capable of accurately detecting the static pressure of the pressure tank 26. In a case where at least one of the first opening and closing valve 24a and the second opening and closing valve 24b is opened, and the working fluid flows through the channels, the first pressure sensor 32a is capable of detecting the dynamic pressure of the pressure tank 26. Similarly, in a case where the third opening and closing valve 24c and the fourth opening and closing valve 24d are closed, and at least one of the vehicle height adjustment valves 14FR and 14FL of the front wheels is opened, the second pressure sensor 32b is capable of detecting the static pressure of the air spring 12. In a case where the third opening and closing valve 24c, the fourth opening and closing valve 24d, and the vehicle height adjustment valves 14RR and 14RL are closed, and one of the vehicle height adjustment valves 14FR and 14FL is opened, the second pressure sensor 32b is capable of detecting the static pressure of the corresponding one of the air springs 12FR and 12FL of the front wheels. In a case where both of the vehicle height adjustment valves 14FR and 14FL are opened, the second pressure sensor 32b is capable of detecting an average static pressure of both of the air springs 12FR and 12FL. In a case where the third opening and closing valve 24c, the fourth opening and closing valve 24d, and the vehicle height adjustment valves 14FR and 14FL are closed, and one of the vehicle height adjustment valves 14RR and 14RL is opened, the second pressure sensor 32b is capable of detecting the static pressure of the corresponding one of the air springs 12RR and 12RL of the rear wheels. When both of the vehicle height adjustment valves 14RR and 14RL are opened, the second pressure sensor 32b is capable of detecting an average static pressure of both of the air springs 12RR and 12RL. In a case where the third opening and closing valve 24c and the fourth opening and closing valve 24d are closed, and the vehicle height adjustment valves 14FR, 14FL, 14RR, and 14RL are opened, the second pressure sensor 32b is capable of detecting the static pressure of all of the air springs 12FR, 12FL, 12RR, and 12RL respectively corresponding to all of the wheels. In a case where the third opening and closing valve 24c or the fourth opening and closing valve 24d is opened, the second pressure sensor 32b is capable of detecting the dynamic pressure of the air spring 12 (the vehicle height adjustment units, that is, the front wheel valve unit 18a and the rear wheel valve unit 18b).

As such, the first pressure sensor 32a is capable of detecting the pressure (static pressure or dynamic pressure) of an upstream side (for example, the pressure tank 26) of the circuit valve block 24. The second pressure sensor 32b is capable of detecting the pressure (static pressure or dynamic pressure) of a downstream side (for example, the air spring 12) of the circuit valve block 24. The working fluid flows from the pressure tank 26 to the air spring 12 due to the pressure difference (differential pressure) between the pressure tank 26 and the air spring 12, and thus, the vehicle height can be adjusted, which will be described later. In other words, since a sufficient amount of the working fluid required to adjust the vehicle height does not flow in a case where the pressure difference is small, the driving of the compressor unit 30 is required. The vehicle height adjustment apparatus 10 is capable of acquiring (calculating) the pressure difference (differential pressure) based on detection results from the first pressure sensor 32a and the second pressure sensor 32b, and controlling the driving of the compressor unit 30 using the calculation result. For example, in a case where when vehicle height increasing control is executed, and the pressure difference between the pressure tank 26 and the air spring 12 is a predetermined value (threshold value) or greater, the working fluid is capable of flowing from the pressure tank 26 to the air spring 12 due to the pressure difference. In this case, it is possible not to drive a compressor 36. In contrast, in a case where the pressure difference between the pressure tank 26 and the air spring 12 is less than the predetermined value (the threshold value), and the vehicle height increasing control is continuously executed, the compressor 36 can be driven at that timing (timing at which pressure feeding of the compressor 36 is required).

For example, the pressure tank 26 is made of metal or resin, and has a capacity and sufficient pressure resistance against pressure occurring in the flow path system when vehicle height adjustment control via the air springs 12 is executed or not. The pressure tank 26 includes a relief valve 26b which reduces the internal pressure of a tank body 26a in a case where the internal pressure of the tank body 26a is a set pressure (pressure set in advance by tests or the like) or greater due to an unknown reason.

The compressor unit 30 includes the following main configuration elements: the compressor 36 driven by a motor 34; a dryer 38; and a throttle mechanism 40 configured to include an orifice 40a and a check valve 40b. In the example illustrated in FIG. 1, the compressor unit 30 further includes a relief valve 42; check valves 44, 46, and 48; filters 50 and 52; and the like.

In a case where the pressure difference between the pressure tank 26 and the air spring 12 is the predetermined valve (value set in advance via tests or the like) or less during vehicle height increasing control, or in a case where the working fluid is pumped (is returned) into the pressure tank 26 from the air spring 12 during vehicle height decreasing control, the compressor 36 of the compressor unit 30 is operated by the motor 34 to pressure-feed the working fluid. The vehicle height adjustment apparatus 10 in the embodiment is a closed type apparatus that adjusts the vehicle height by moving the working fluid in the flow paths (air which has been initially sealed in the flow paths when the vehicle height adjustment apparatus 10 is built) between the pressure tank 26 and the air spring 12. Accordingly, basically, it is considered that external air may not infiltrate into the apparatus, and there may be no environmental changes, for example, a humidity change. Accordingly, basically, it is possible to omit the dryer 38 or the throttle mechanism 40 from the closed type apparatus. The working fluid (air) in the apparatus may leak to the outside due to an unknown reason. In this case, the working fluid in the apparatus is supplemented by suctioning the atmosphere (the outside air) from the outside via the filter 52 and the check valve 48. At this time, the atmosphere (the outside air) may contain moisture (humidity) that adversely affects the internal configuration components of the vehicle height adjustment apparatus 10. For this reason, the vehicle height adjustment apparatus 10 illustrated in FIG. 1 includes the dryer 38 and the throttle mechanism 40 on the downstream side of the compressor 36. The dryer 38 removes a predetermined amount of humidity from the suctioned atmosphere, and the throttle mechanism 40 adjusts the passing speed of the atmosphere passing through the dryer 38. The compressor unit 30 includes the relief valve 42 so as to reduce the internal pressure of the vehicle height adjustment apparatus 10 in a case where the internal pressure of the vehicle height adjustment apparatus 10 exceeds a limit pressure due to an unknown reason. For example, the relief valve 42 includes an ON/OFF controlled solenoid and a spring. A normally closed electro-magnetic control valve, which is closed in a case where the solenoid is not energized, can be used as the relief valve 42. The relief valve 42 in the embodiment is not a valve of the type which always maintains a closed valve state when the valve is not energized. The relief valve 42 includes a check valve 54 that allows the flowing of the working fluid to the atmosphere in a case where the internal pressure of the vehicle height adjustment apparatus 10 exceeds the limit pressure (pressure set in advance via tests or the like). For example, in a case where the internal pressure of the vehicle height adjustment apparatus 10 exceeds the limit pressure due to the occurrence of an unknown malfunction, the check valve 54 is opened which counteracts biasing force, and the internal pressure is automatically reduced to the limit pressure or less. The relief valve 42 can be opened according to control signals from a control unit (to be described later), and is capable of reducing the internal pressure of the vehicle height adjustment apparatus 10, regardless of the limit pressure. The compressor 36 also serves as a supply source supplying the working fluid to the air springs 12.

The vehicle height adjustment apparatus 10 with this configuration executes control related to vehicle height adjustment of the vehicle height adjustment units (the air springs, the vehicle height adjustment valves or the like, which will be described later) via a control unit (ECU) 56 included in the vehicle height adjustment apparatus 10. For example, the ECU 56 is capable of acquiring a vehicle height adjustment demand, a detection result from a vehicle height sensor 58 detecting an extended and contracted state (vehicle height) of each of the air springs 12, and detection results from the first pressure sensor 32a and the second pressure sensor 32b via a controller area network (CAN). The ECU 56 controls the opening and closing of the vehicle height adjustment valves 14FR, 14FL, 14RR, 14RL, the first opening and closing valve 24a, the second opening and closing valve 24b, the third opening and closing valve 24c, the fourth opening and closing valve 24d, the relief valve 42, and the like, or controls the driving of the motor 34, based on the acquired information. In the example illustrated in FIG. 1, the single ECU 56 integrally controls each control target. However, a control unit may be provided to individually control each control target. Alternatively, control units may be provided to respectively control groups of several control targets, and a host control unit may be provided to integrally control the control units.

As described above, in the vehicle height adjustment apparatus 10 of the embodiment, the first pressure sensor 32a is disposed on the upstream side of the circuit valve block 24, and the second pressure sensor 32b is disposed on the downstream side of the circuit valve block 24 such that the first pressure sensor 32a and the second pressure sensor 32b are capable of respectively detecting the pressure of the pressure tank 26 and the pressure of the air spring 12. Particularly, the first pressure sensor 32a and the second pressure sensor 32b are capable of detecting pressure in real time during vehicle height increasing control. As a result, the ECU 56 is capable of accurately determining whether or not the flowing of the working fluid caused by the pressure difference can be enabled. In a case where the pressure difference is not sufficient, the ECU 56 is capable of driving the compressor 36 for only a necessary amount of time at a proper timing. As a result, it is possible to optimize control of the driving of the compressor 36, to execute low power consumption control, and to reduce noise or vibration caused by the driving of the compressor 36. The first pressure sensor 32a and the second pressure sensor 32b are capable of respectively detecting the pressure of the pressure tank 26 and the pressure of the air spring 12 in real time, and the detection results can be reflected in control of the vehicle height. For example, as described above, the vehicle height adjustment apparatus 10 is capable of smoothly adjusting the vehicle height at all times by driving the compressor 36 at the proper timing. The vehicle height adjustment apparatus 10 is capable of smoothly adjusting the vehicle height according to road surface conditions. As a result, it is possible to improve riding comfort, or maneuverability.

Since the vehicle height adjustment apparatus 10 is capable of operating the compressor 36 at a proper timing, for example, also in a case where the wheels travel onto a curb or the like, and the vehicle body is inclined in a lateral direction, it is possible to maintain the vehicle body to be in a substantially horizontal state in actuality by properly adjusting the vehicle height, and to reduce the discomfort or anxiety of an occupant and the like. Force exerted (force exerted on a hinge portion) to a door when the door is opened and closed can be maintained at the same level of force as a case where the vehicle body is in a horizontal state, and thus, to easily open and close the door. It is possible to allow the same level of ease of boarding and alighting as a case where the vehicle body is in a horizontal state.

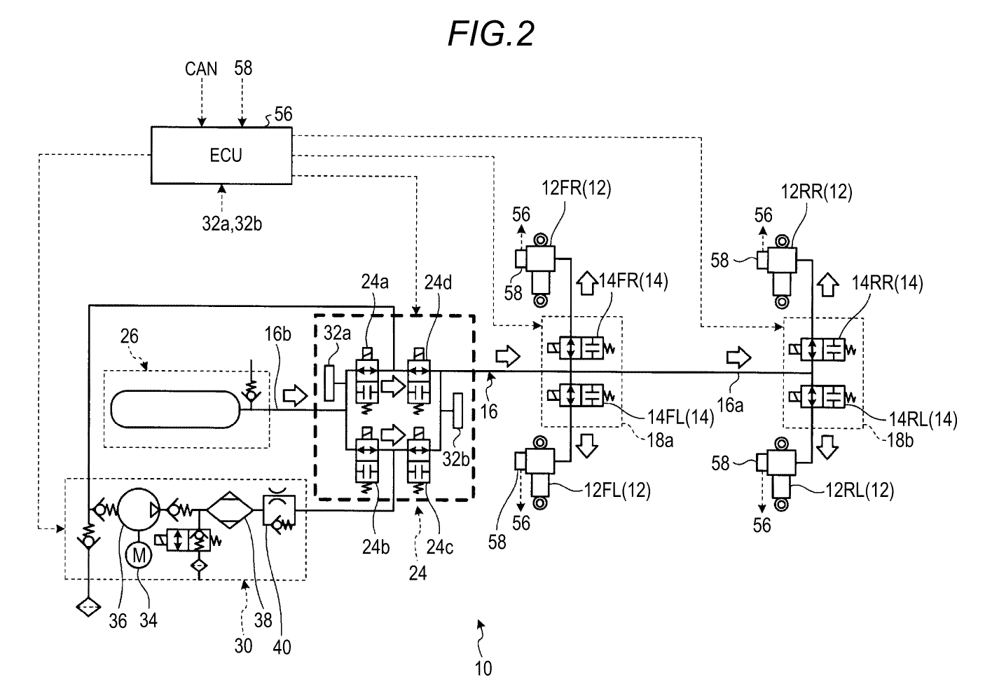

Vehicle height increasing control and vehicle height decreasing control performed by the vehicle height adjustment apparatus 10 with this configuration will be described in detail with reference to FIGS. 2 to 4.

In a description of the operation of the vehicle height adjustment apparatus 10 in a case where the vehicle height increasing control is executed, which will be given with reference to FIG. 2, the pressure of the pressure tank 26 is sufficiently higher than that of the air spring 12, and the working fluid (air) is capable of flowing from the pressure tank 26 to the air spring 12 due to the pressure difference between the pressure tank 26 and the air spring 12. The ECU 56 determines whether or not the flowing of the working fluid (air) caused by the pressure difference can be enabled by acquiring the pressure of the pressure tank 26 based on the detection result from the first pressure sensor 32a, and the pressure of the air spring 12 based on the detection result from the second pressure sensor 32b, and calculating the pressure difference therebetween.

In a case where the vehicle height adjustment apparatus 10 executes vehicle height increasing control, the ECU 56 controls the opening and closing of the first opening and closing valve 24a, the second opening and closing valve 24b, the third opening and closing valve 24c, and the fourth opening and closing valve 24d included in the circuit valve block 24, and executes control such that the vehicle height adjustment valves 14FR, 14FL, 14RR, and 14RL are opened.

The vehicle height adjustment apparatus 10 in the embodiment is capable of switching a flow mode (flow direction, flow rate, or the like) of the working fluid by changing the combination of the respective opening and closing states of the first opening and closing valve 24a, the second opening and closing valve 24b, the third opening and closing valve 24c, and the fourth opening and closing valve 24d of the circuit valve block 24. For example, in a case where the working fluid flows from the pressure tank 26 to the vehicle height adjustment unit (the air spring 12) due to the pressure difference therebetween, the ECU 56 is capable of selectively using at least one of a first flow path system and a second flow path system. The first flow path system is formed by opening the first opening and closing valve 24a and the fourth opening and closing valve 24d, and the second flow path system is formed by opening the second opening and closing valve 24b and the third opening and closing valve 24c. For example, in a case where a first flow mode (ease of flowing associated with the opening diameter of a flow path and flow resistance) of the first flow path system is actually the same as a second flow mode (flow passage opening diameter due to the ease of flow associated with flow resistance) of the second flow path system, the ECU 56 is considered to select either one of the first path system or the second flow path system. In this case, the working fluid flowing out from the pressure tank 26 via the tank connection main flow path 16b can be supplied to each of the air springs 12 in a first speed mode (for example, a low-speed increasing mode) while passing through the first flow path system or the second flow path system. The air springs 12 are extended via opening of the vehicle height adjustment valves 14, and thus, the vehicle height can be increased at a low speed.

In a case where the ECU 56 selects both the first flow path system and the second flow path system, ease of the flowing of the working fluid is substantially two times better than a case where the ECU 56 selects either one of the first flow path system or the second flow path system. The working fluid can be supplied to each of the air springs 12 in a second speed mode (for example, a high-speed increasing mode) which is faster than the first speed mode. As a result, the air springs 12 are extended via opening of the vehicle height adjustment valves 14, and thus, the vehicle height can be increased at a higher speed than the first speed mode.

As such, the ECU 56 is capable of easily switching the flowing of the working fluid (the flow rate of the working fluid) per unit time, and easily changing the vehicle height increasing speed by selecting the first flow path system and the second flow path system. The ECU 56 is capable of adjusting the amount of the working fluid supplied to the air springs 12 by reducing a flow rate via selecting of either one of the first flow path system or the second flow path system. That is, fine adjustment of the internal pressure (spring pressure) of each of the air springs 12 is easily executed. In another embodiment, the first flow mode of the first flow path system specified by the opening of the first opening and closing valve 24a and the fourth opening and closing valve 24d may be set to be different from the second flow mode of the second flow path system specified by the opening of the second opening and closing valve 24b and the third opening and closing valve 24c. For example, the opening diameter of an opening and closing valve of the second flow path system is set to be larger than that of the first flow path system. As a result, in a case where the ECU 56 selects the first flow path system by opening the first opening and closing valve 24a and the fourth opening and closing valve 24d, each of the air springs 12 can be set to the low-speed increasing mode, or fine adjustment of the internal pressure of each of the air springs 12 can be executed. In a case where the ECU 56 selects the second flow path system by opening the second opening and closing valve 24b and the third opening and closing valve 24c, each of the air springs 12 can be set to a medium-speed increasing mode, or medium adjustment of the internal pressure of each of the air springs 12 can be executed. In a case where the ECU 56 selects both the first flow path system and the second flow path system, each of the air springs 12 can be set to the high-speed increasing mode, or high-speed adjustment of the internal pressure of each of the air springs 12 can be executed.

The first flow path system and the second flow path system may be selected multiple times during one vehicle height increasing process. For example, the vehicle height increasing speed in an initial period of a vehicle height increasing operation may be set to the first speed mode in which either one of the first flow path system or the second flow path system is used. The vehicle height increasing speed in an intermediate period may be set to the second speed mode in which both of the first flow path system and the second flow path system are used, and which is faster than the first speed mode. The vehicle height increasing speed in a final period may be set to the first speed mode again. The vehicle height is started to be slowly increased in the first speed mode, thereby being able to reduce a jolt occurring when the vehicle height is started to be increased. The speed mode transitions to the second speed mode in the intermediate period, that is, the vehicle height is increased at a high speed, thereby being able to reduce the amount of time required to complete the vehicle height increasing control. The speed mode is switched to the first speed mode again in the final period, that is, the vehicle height is slowly increased, thereby being able to reduce a jolt occurring when the increasing of the vehicle height is stopped.

As illustrated in FIG. 2, in the vehicle height adjustment apparatus 10 of the embodiment, the second end of the second opening and closing valve 24b and the first end of the third opening and closing valve 24c are connected to the throttle mechanism 40, and the second end of the second opening and closing valve 24b is also connected to the first end of the third opening and closing valve 24c. That is, in a case where the working fluid flows to the air springs 12 based on the pressure difference between the pressure tank 26 and the air springs 12, regardless of the throttle mechanism 40, that is, the compressor unit 30, the working fluid is capable of passing through either one of or both of the first flow path system formed by the first opening and closing valve 24a and the fourth opening and closing valve 24d and the second flow path system formed by the second opening and closing valve 24b and the third opening and closing valve 24c. In other words, in a case where the flowing of the working fluid is enabled due to the pressure difference, the working fluid does not pass through the compressor unit 30. Accordingly, it is possible to simplify the flow path in a case where the flowing of the working fluid is enabled due to the pressure difference, and to reduce the occurrence of pressure loss during flowing of the working fluid.

In the vehicle height adjustment apparatus 10, basically, the working fluid flows to the air springs 12 due to the pressure difference between the pressure tank 26 and the air springs 12. In contrast, as a result of the flowing of the working fluid from the pressure tank 26 to the air springs 12, the pressure difference between the pressure tank 26 and the air springs 12 may disappear such that a sufficient amount of the working fluid does not flow. In addition, when vehicle height increasing control is started, the pressure difference (differential pressure) between the pressure tank 26 and the air springs 12 may not be sufficient. In this case, the ECU 56 drives the motor 34 of the compressor unit 30 such that the compressor 36 forcibly pumps the working fluid from the pressure tank 26, and pressure-feeds the working fluid to the air springs 12.

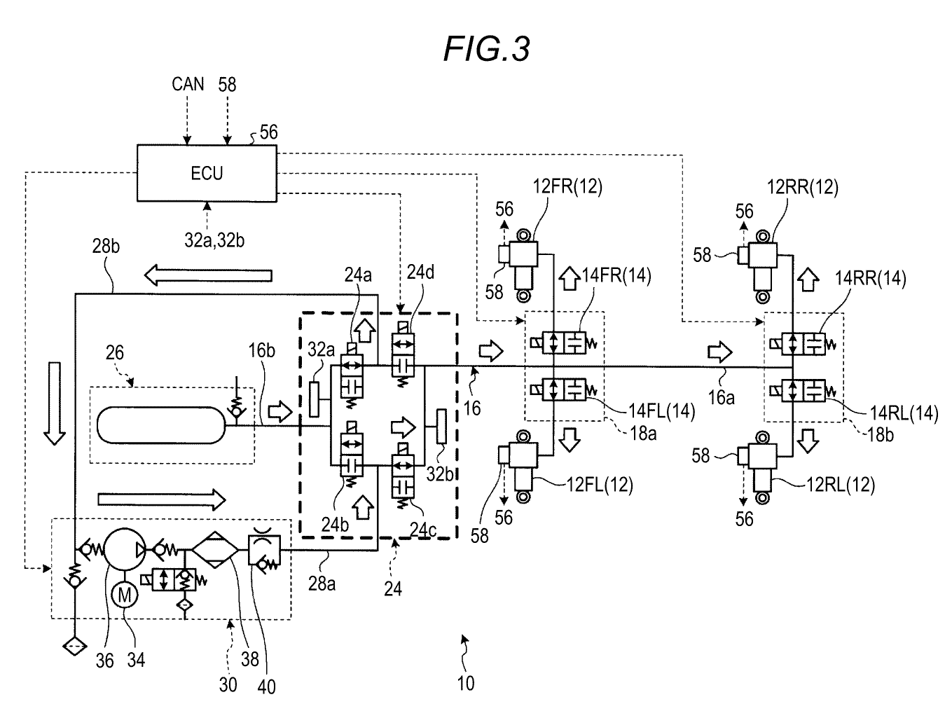

FIG. 3 illustrates the operation of the vehicle height adjustment apparatus 10 in a case where the compressor 36 pressure-feeds the working fluid to the air springs 12 during vehicle height increasing control. For example, in a case where the pressure difference between the pressure tank 26 and the air springs 12 is determined to the predetermined value or less based on detection results from the first pressure sensor 32a and the second pressure sensor 32b, the ECU 56 switches the respective opening and closing states of the first opening and closing valve 24a, the second opening and closing valve 24b, the third opening and closing valve 24c, and the fourth opening and closing valve 24d, and starts to pressure-feed the working fluid via the compressor 36. The predetermined value for the pressure difference used as a trigger to switch the opening and closing states can be determined based on testing carried out in advance and the like. For example, the differential pressure value can be determined to set the vehicle height increasing speed to become less than a predetermined value. In this case, pressure feeding of the compressor 36 is desirably started before the increasing of the vehicle height is stopped.

In another embodiment, pressure feeding of the compressor 36 may be started based on a detection result from the vehicle height sensors 58. That is, a decrease in the pressure difference between the pressure tank 26 and the air spring 12 causes a decrease in the vehicle height increasing speed. Accordingly, in a case where the ECU 56 calculates the vehicle height increasing speed by time-differentiating a vehicle height value from each of the vehicle height sensors 58, and the vehicle height increasing speed is the predetermined value (lower limit increasing speed determined in advance via tests or the like) or less, the ECU 56 may start to pressure-feed the working fluid via the compressor 36. The ECU 56 may determine a start of the driving of the compressor 36 using the detection results from the first pressure sensor 32a and the second pressure sensor 32b and the detection results from the vehicle height sensors 58.

As illustrated in FIG. 3, in a case where a pressure difference calculated based on the detection results from the first pressure sensor 32a and the second pressure sensor 32b is the predetermined value or less, or in a case where the vehicle height increasing speed calculated based on the vehicle height values detected by the vehicle height sensors 58 is the predetermined value or less, the ECU 56 opens the first opening and closing valve 24a, and closes the fourth opening and closing valve 24d. In this state, the pressure tank 26 communicates with the compressor 36. The second opening and closing valve 24b is closed, and the third opening and closing valve 24c is opened. In this state, the compressor 36 communicates with the air springs 12. As a result, in a case where the compressor 36 is driven, the working fluid in the pressure tank 26 is pumped into the compressor 36 via the tank connection main flow path 16b, the first opening and closing valve 24a, and the compressor inlet flow path 28b. The pumped working fluid is compressed, and pressure-fed to the air springs 12 via the compressor outlet flow path 28a and the third opening and closing valve 24c. As a result, vehicle height increasing control of each of the air springs 12 can be executed even in a state where the pressure difference between the pressure tank 26 and the air springs 12 is not sufficient. In this case, the vehicle height increasing speed is determined by the output of the compressor 36, that is, the output of the motor 34. For this reason, the ECU 56 controls the output of the motor 34 according to a requested vehicle height increasing speed, for example, a high-speed vehicle height increasing request or a low-speed vehicle height increasing request. As described above, the ECU 56 may control the output of the motor 34 to change the vehicle height increasing speed multiple times in one vehicle height increasing process.

In a case where a pressure difference is present between the pressure tank 26 and the air springs 12, and the weight of the vehicle is increased, for example, the number of users (occupants) of the vehicle is increased, or cargoes are increased, before or during vehicle height increasing control, the magnitude of a load to be carried by the air springs 12 is increased, and thus, the air springs 12 are contracted. As a result, the pressure difference (differential pressure) between the pressure tank 26 and the air spring 12 may disappear due to an increase in the pressure of the air springs 12. Also, in this case, the vehicle height increasing speed is decreased. The situation can be detected based on detection values from the first pressure sensor 32a and the second pressure sensor 32b or detection values from the vehicle height sensors 58. Accordingly, the ECU 56 is capable of starting pressure feeding of the compressor 36 at a proper timing.

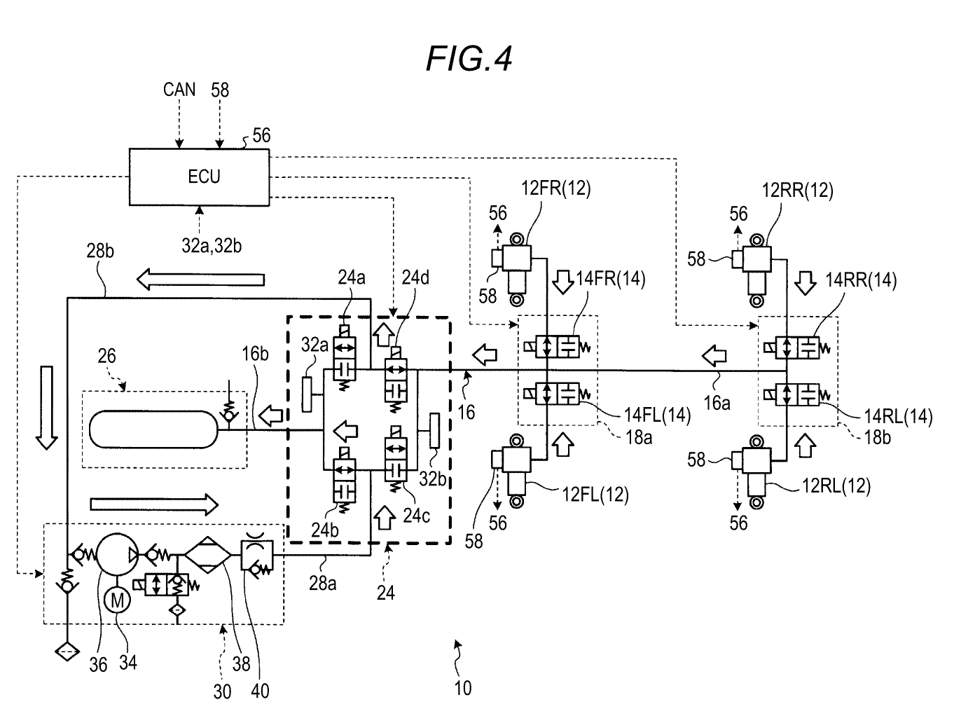

Subsequently, the operation of the vehicle height adjustment apparatus 10 during vehicle height decreasing control will be described with reference to FIG. 4. For example, in a case where the ECU 56 acquires a vehicle height decreasing request via the CAN, the ECU 56 switches the respective opening and closing states of the first opening and closing valve 24a, the second opening and closing valve 24b, the third opening and closing valve 24c, and the fourth opening and closing valve 24d. As a result, the compressor 36 is capable of pumping the working fluid from the air springs 12, and returning (pressure-feeding the working fluid to the pressure tank 26) the pumped working fluid to the pressure tank 26, and thus, the air springs 12 are contracted, and the vehicle height can be decreased.

As illustrated in FIG. 4, in a case where the vehicle height decreasing control is executed, the ECU 56 closes the first opening and closing valve 24a, and opens the fourth opening and closing valve 24d. In addition, the second opening and closing valve 24b is opened, and the third opening and closing valve 24c is maintained closed. The vehicle height adjustment valves 14FR, 14FL, 14RR, and 14RL are opened. As a result, the air springs 12 communicate with the compressor 36 via the fourth opening and closing valve 24d and the compressor inlet flow path 28b. The outlet of the compressor 36 communicates with the pressure tank 26 via the compressor outlet flow path 28a, the second opening and closing valve 24b, and the tank connection main flow path 16b. The working fluid of the air springs 12 is pumped and pressure-fed to the pressure tank 26 by the compressor 36.

In the vehicle height decreasing control, the vehicle height decreasing speed is dependent on the pumping speed of the working fluid pumped by the compressor 36. That is, since the ECU 56 is capable of arbitrarily adjusting the output of the motor 34, the ECU 56 is capable of arbitrarily selecting the vehicle height decreasing speed. Accordingly, the ECU 56 increases the output of the motor 34 in a case where the vehicle height decreasing speed is desired to be increased, and the ECU 56 decreases the output of the motor 34 in a case where the vehicle height decreasing speed is desired to be decreased. For example, in a case where occupants including a driver park (stop), and move away from a vehicle, the occupants may be notified that the vehicle is transitioned to a resting state. In this case, it is possible to show the vehicle in a resting state by quickly decreasing the vehicle height to a vehicle height lower than a normal vehicle height while the occupants including the driver stay in the vicinity of the vehicle, for example, within a few seconds after the driver turns off a drive source of the vehicle, alights from the vehicle, and locks the doors. In a case where stable travelling can be obtained by decreasing the vehicle height during travelling, it is possible to decrease the vehicle height in a speed range in which occupants do not have the discomfort while stable travelling is maintained.

The ECU 56 is capable of adjusting the decreased amount of the vehicle height by controlling a drive period of the compressor 36. For example, it is possible to make the silhouette of a parked or stopped vehicle look beautiful by decreasing the vehicle height in a case where occupants including a driver park (stop), and move away from the vehicle. The decreasing of the vehicle height is capable of contributing to suppression of a theft of the wheels or the vehicle. In a case where vehicle height decreasing control is executed, the occurrence of damage to the vehicle is desirably prevented by detecting whether or not obstacles are present on a surface below the vehicle or in the vicinity of the vehicle.

The vehicle height adjustment apparatus 10 with this configuration is capable of executing vehicle height adjustment to reduce burdens to a user when boarding and alighting. In a case where the user boards and alights from a vehicle, the user takes a boarding and alighting posture corresponding to the height of a seat. In many cases, a user boards and alights from a sedan type vehicle while bending the body. Since a sport type vehicle has a seat height lower than that of a typical passenger vehicle, a user is required to further bend the body. In contrast, a sport utility vehicle (SUV) or the like has a seat height higher than that of a sedan type vehicle or the like. For this reason, a user may be required to take a tiptoe posture for boarding and alighting. That is, burdens to a user when boarding and alighting are reduced by adjusting the vehicle height to be suitable for boarding and alighting. Another use mode of the vehicle height adjustment apparatus 10 may refer to a case where vehicle height adjustment is executed so as to make the appearance of a parked vehicle look attractive. For example, it may be able to make the silhouette of a sedan type vehicle look more beautiful by decreasing the vehicle height of the sedan type vehicle. In an SUV, the increasing of the vehicle height may make the silhouette of the SUV look more beautiful. That is, in a case where the vehicle height adjustment apparatus 10 (vehicle) is capable of switching between at least two different vehicle heights (for example, a first vehicle height and a second vehicle height), the added value of the vehicle height adjustment apparatus 10 (vehicle) can be improved. For example, a vehicle height suitable for boarding and alighting may be set to the first vehicle height, and a vehicle height suitable for parking may be set to the second vehicle height. In this case, it is possible to provide a vehicle with an improved added value, in which comfort boarding and alighting or comfort parking is taken into consideration.

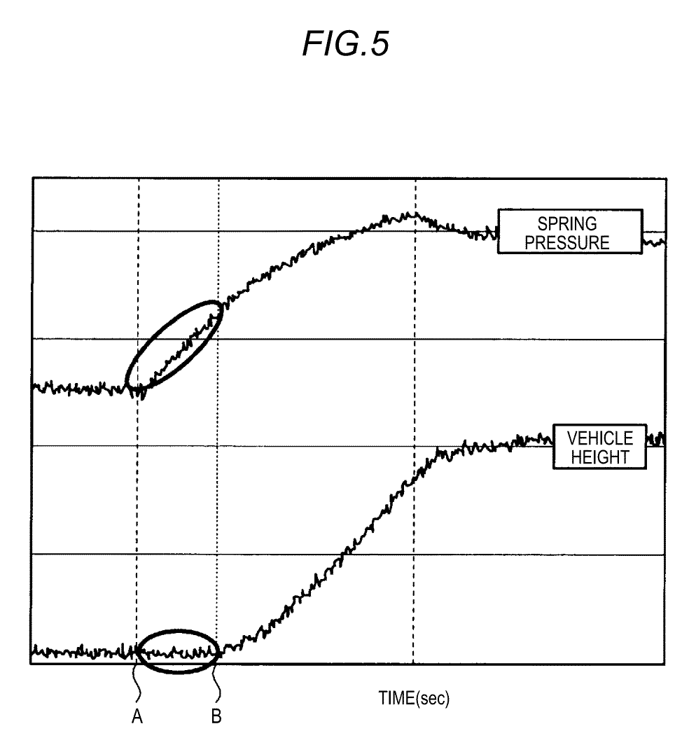

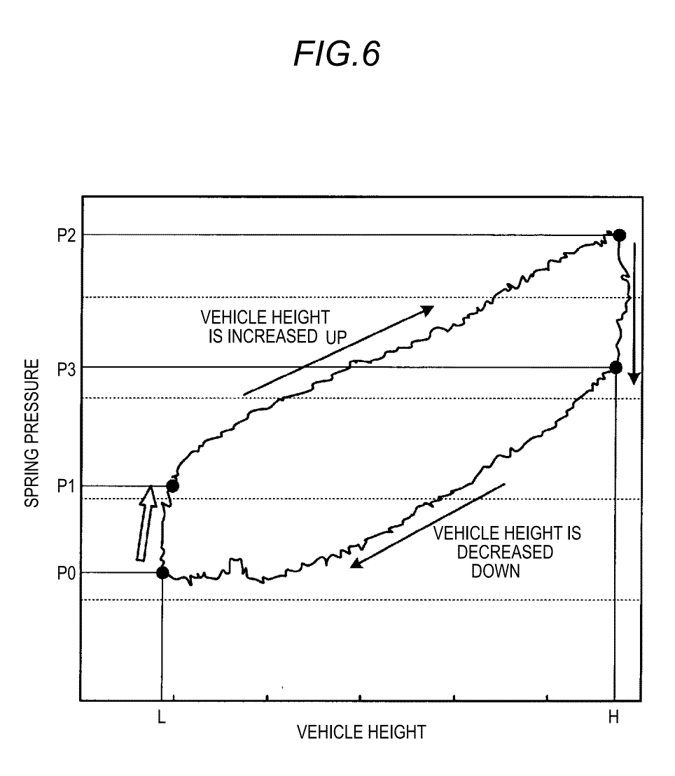

As described above, in a case where the vehicle height is changed to the first vehicle height for boarding and alighting, and to the second vehicle height for parking, a vehicle height change is desirably made smoothly and quickly. Particularly, typically, the amount of time between when a door opening operation is executed and when a user boards a vehicle is short, and a vehicle height change is preferably executed quickly. Each of the air springs 12 may have frictional resistance associated with an upward and downward operation. Due to the frictional resistance as one of causes, as illustrated in FIG. 5, even if supply of the working fluid (for example, high-pressure air)from the pressure tank 26 to the air springs 12 is started at time A, and a spring pressure change is started, a vehicle height change may be started at time B. FIG. 6 illustrates a relationship between a change in the spring pressure of the air spring 12 and a vehicle height change made by the air spring 12 in a case where the vehicle height is increased. As illustrated in FIG. 6, even if supply of the working fluid is started when the vehicle is positioned at the second vehicle height (vehicle height L) suitable for parking, and the spring pressure of the air spring 12 is increased from spring pressure P0, the vehicle height is not increased, and the vehicle height is started to be increased to the first vehicle height (vehicle height H) suitable for boarding after the occurrence of spring pressure P1 to overcome frictional resistance. As a result, a user may encounter a situation in which the vehicle height is not yet increased to the vehicle height suitable for boarding when the user opens a door and boards the vehicle. It is considered that the vehicle height for boarding is quickly increased. In contrast, in a case where a user merely approaches, and does not board a vehicle, a vehicle height change looks unnatural because the vehicle without passengers is moved, and an unnecessary vehicle height change is made, which is not preferable.

The ECU (control unit) 56 of the vehicle height adjustment apparatus 10 in the embodiment preadjusts the working fluid supply and discharge state of each of the air springs (vehicle height adjustment units) 12 to a vehicle height change start state before changing the second vehicle height (the vehicle height L) to the first vehicle height (the vehicle height H). As illustrated in FIG. 6, in a case where the vehicle height is increased for boarding, the internal pressure of each of the air springs 12 is increased in advance to spring pressure immediately before a vehicle height change is started (the spring pressure PO changed to the spring pressure P1). That is, the appearance of the vehicle is not changed at all, and the vehicle height is increased immediately when the vehicle height is desired to be increased (when a user boards the vehicle).

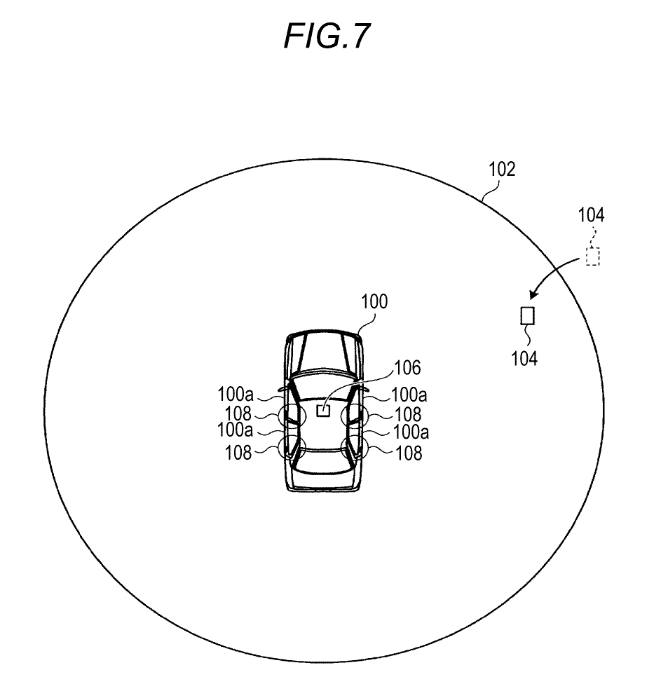

Specifically, the ECU 56 acquires first operation start information for executing preadjustment, and second operation start information for changing the vehicle height to the first vehicle height (the vehicle height H). For example, as illustrated in FIG. 7, the first operation start information refers to information indicating that a user enters a first detection region 102 centered around a vehicle 100. It is possible to detect whether or not a user enters the first detection region 102 by detecting whether or not transmission and reception of information (signals) between the vehicle 100 and a portable terminal held by the user is established. Specifically, in recent years, the vehicle 100 may feature a keyless entry system, a smart entry system, or the like as a standard device or an optional device. In a smart entry system, a user holds a portable terminal (a smart key, a key holder, or a remote key) 104. In a case where communication is established between the portable terminal 104 and a control apparatus 106 of the smart entry system featured in the vehicle 100 (in a case where authentication is established), the control apparatus 106 turns on an interior light, or turns on and off hazard lamps to report the establishment of the authentication. Subsequently, in a case where a user touches a door handle, operates the door handle, or operates a switch disposed in the vicinity of the door handle, door locking is released. The communication (authentication) between the portable terminal 104 and the vehicle 100 is executed in a predetermined range (for example, range within a radius of several meters to several tens of meters from the vehicle 100 as a center) set around the vehicle 100, and this range can be used as the first detection region 102.

In an example illustrated in FIG. 7, the first detection region 102 refers to a region in which the portable terminal 104 is capable of communicating with the control apparatus 106. In a case where the portable terminal 104 enters the first detection region 102 (in a case where a user holding the portable terminal 104 enters the first detection region 102), communication (authentication) is executed. Authentication information indicating the establishment of the authentication is provided to the ECU 56. As a result, the ECU 56 is capable of using the authentication information as the first operation start information to trigger execution of the preadjustment.

That is, in a case where the ECU 56 detects that a user enters the first detection region 102, the ECU 56 supplies the working fluid from the pressure tank 26 to the air springs 12 via at least one of the first flow path system, which is formed by opening the first opening and closing valve 24a and the fourth opening and closing valve 24d of the circuit valve block 24, and the second flow path system which is formed by opening the second opening and closing valve 24b and the third opening and closing valve 24c. At this time, the working fluid is supplied to the air springs 12FR, 12FL, 12RR, and 12RL, and the spring pressure of each of the air springs 12 is increased by opening the vehicle height adjustment valves 14FR, 14FL, 14RR, and 14RL. As described above, the vehicle height is not changed at this point in time. For this reason, for example, the ECU 56 monitors a vehicle height change based on signals from the vehicle height sensor 58 disposed in each of the air springs 12, and ends the preadjustment by closing the vehicle height adjustment valves 14FR, 14FL, 14RR, and 14RL immediately after the vehicle height is changed. At this time, the ECU 56 may end the preadjustment by shutting off the first flow path system or the second flow path system via controlling of the circuit valve block 24. Alternatively, the ECU 56 may end the preadjustment by controlling both the vehicle height adjustment valves 14 and the circuit valve block 24.

In a case where the vehicle 100 is parked at the second vehicle height (the vehicle height L), the air springs 12 are stationary in a state where a predetermined amount of the working fluid required to maintain the second vehicle height (the vehicle height L) is sealed in the air springs 12. Static frictional force at that time is assumed to be constant. Accordingly, it is possible to determine the supplied amount of the working fluid in advance, which is required to extend the air springs 12 to overcome the static frictional force. The ECU 56 may complete the preadjustment by supplying a first predetermined amount of the working fluid to the air springs 12 via controlling of the circuit valve block 24 or the vehicle height adjustment valves 14 after acquiring the first operation start information. In this case, since feedback control based on detection signals from the vehicle height sensors 58 can be omitted, the process can be simplified. The ECU 56 may supply a second predetermined amount of the working fluid, which is slightly less than the first predetermined amount, and thereafter, may fine adjust the amount of supply based on detection results from the vehicle height sensors 58. In this case, the second predetermined amount may be supplied at a high speed, and thereafter, fine adjustment may be executed. As a result, it is possible to reduce the amount of control time required to complete the preadjustment. The ECU 56 is capable of calculating the first predetermined amount or the second predetermined amount of the working fluid supplied to the air springs 12, based on the amount of control time of the circuit valve block 24 or the vehicle height adjustment valves 14, and the pressure difference between the pressure tank 26 and the air springs 12.

Subsequently, the ECU 56 acquires the second operation start information for changing the vehicle height to the first vehicle height (the vehicle height H). That is, information to trigger an actual vehicle height increase is acquired. For example, as illustrated in FIG. 7, the second operation start information refers to information indicating that a user enters a second detection region 108 centered around a door of the vehicle 100. The second detection region 108 refers to a region included in the first detection region 102, and in which it is determined whether or not a user approaches the vehicle having an intention of boarding the vehicle (whether or not a user enters the second detection region 108). In this case, the presence of a user may be detected directly or indirectly. Door open information, door lock release information, or the like can be used as the second operation start information. Any of the items of information is based on an operation required to board the vehicle. The presence of a user may be indirectly detected based on the door open information, for example, a turn-on signal of a courtesy lamp which is turned on when a door is opened. A door-knob operation state may be detected, and may be used as the door open information. In a case where a door handle is provided with a capacitive sensor, when the capacitive sensor detects that a user touches the door handle, or gets a hand close to the door handle to touch the door handle, the presence of the user may be directly detected. Signals for an unlocking operation via a keyless entry system or a smart entry system may be used as the door open information. An operation state of the switch disposed in the vicinity of the door handle, a door cylinder, or the related members may be detected, and used. Any one of the items or a combination of multiple items of boarding preparation information may be used.

In the example illustrated in FIG. 7, the vehicle 100 is a four-door vehicle, and the second detection region 108 is set for each door 100a. Accordingly, the ECU 56 is capable of identifying a door used by a user for boarding, based on an acquired position of the second operation start information.

In a case where the ECU 56 detects that a user enters the second detection region 108, for example, that a user operates the door handle or the like, the ECU 56 supplies the working fluid from the pressure tank 26 to the air springs 12 via at least one of the first flow path system, which is formed by opening the first opening and closing valve 24a and the fourth opening and closing valve 24d of the circuit valve block 24, and the second flow path system which is formed by opening the second opening and closing valve 24b and the third opening and closing valve 24c. The ECU 56 increases the spring pressure of each of the air springs 12 by opening the vehicle height adjustment valves 14FR, 14FL, 14RR, and 14RL, and supplying the working fluid to the air springs 12FR, 12FL, 12RR, and 12RL, and thus, the vehicle height of the vehicle 100 is changed to the first vehicle height (the vehicle height H). As described above, each of the air springs 12 is brought into a vehicle height change start state by the preadjustment (the spring pressure P1 illustrated in FIG. 6). Accordingly, the vehicle height can be started to be increased, and can be changed from the second vehicle height (the vehicle height L) to the first vehicle height (the vehicle height H) immediately when the working fluid is supplied from the pressure tank 26. The ECU 56 monitors a vehicle height change based on signals from the vehicle height sensor 58 disposed in each of the air springs 12. The ECU 56 seals the air springs 12, and maintains the extended states of the air springs 12 by closing the vehicle height adjustment valves 14FR, 14FL, 14RR, and 14RL in a case where the vehicle height reaches the first vehicle height (the vehicle height H) set in advance. In this case, the extended states of the air springs 12 may be maintained by shutting the first flow path system or the second flow path system via controlling of the circuit valve block 24. Since the length of the flow path to each of the air springs 12 is increased in a case where the circuit valve block 24 is controlled, the extended states of the air springs 12 may be slightly changed due to compression of the working fluid or the like. Accordingly, the extended states of the air springs 12 are desirably maintained by controlling the vehicle height adjustment valves 14.

In a case where the sitting surface of a seat is inclined when boarding, a user can smoothly board the vehicle, or may feel safe. In the vehicle height adjustment apparatus 10 of the embodiment, in a case where the ECU 56 controls the air springs 12 to realize the first vehicle height, the ECU 56 may incline the vehicle body in the lateral direction of the vehicle. For example, in a case where a seat to be boarded is inclined downward to the outside of a door, a user easily sits in the seat. As a result, the user can smoothly perform a boarding operation. In this case, the ECU 56 adjusts the vehicle height to a first inclination vehicle height by extending the air spring 12 on a non-boarding side longer than the air spring 12 on a boarding side. In this case, it is not necessarily required to extend the air spring 12 on the boarding side to the same height as the first vehicle height in a non-inclined state. For example, the air spring 12 on the boarding side may be extended to 80% of the height in a non-inclined state, and the air spring 12 on the non-boarding side may be extended to 100% of the height in a non-inclined state. Alternatively, the air spring 12 on the boarding side may be extended to 100% of the height in a non-inclined state, and the air spring 12 on the non-boarding side may be extended to 120% of the height in a non-inclined state. The ECU 56 is capable of determining a door used by a user for boarding, that is, a direction in which the vehicle 100 has to be inclined, based on the position of a door for which the second operation start information is acquired.

In another embodiment, the inclination vehicle height may be set in such a way that a seat to be boarded is inclined upward to the outside of a door. That is, the inside of the sitting surface of the seat in the lateral direction may be lower than the outside. In this case, a sitting seat holds a user well. As a result, a sense of safety when boarding is improved.

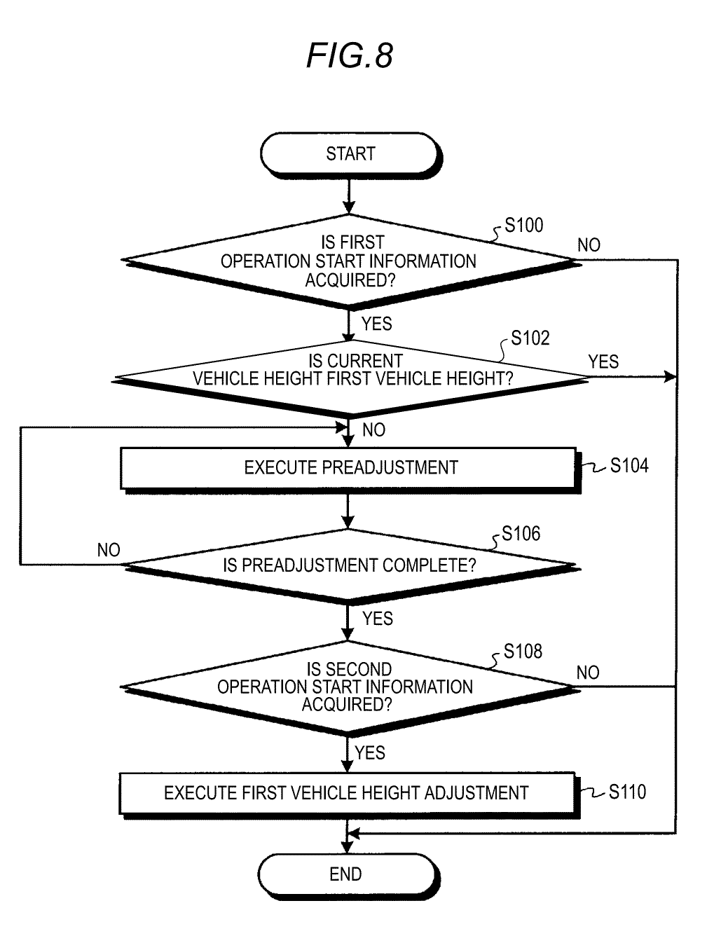

The operation of the vehicle height adjustment apparatus 10 will be described with reference to the flowchart illustrated in FIG. 8. The example illustrated in FIG. 8 will be described based on the assumption that the vehicle 100 is a sedan type vehicle, and is parked at the second vehicle height (low vehicle height) suitable for parking, and a user approaches the vehicle 100 for boarding.

In order to realize a smart entry function, the vehicle 100 monitors whether or not the communicable (authenticable) portable terminal 104 enters the first detection region 102. That is, in a case where communication is established between the portable terminal 104 and the control apparatus 106 of the smart entry system, the ECU 56 is considered to acquire the first operation start information (S100: Yes). The ECU 56 confirms whether or not a current vehicle height of the vehicle 100 is the first vehicle height (the vehicle height H), based on detection results from the vehicle height sensors 58 (S102). In a case where the current vehicle height is not the first vehicle height (the vehicle height H), that is, the current vehicle height is not the first vehicle height suitable for boarding, or in a case where the current vehicle height is not the second vehicle height (the vehicle height L), and does not reach the first vehicle height (the vehicle height H) (S102: No), the ECU 56 executes preadjustment (S104). That is, the ECU 56 increases the spring pressure of the air springs 12 to a vehicle height change start state by opening the vehicle height adjustment valves 14 so as to supply the working fluid from the pressure tank 26 to the air springs 12 for the preadjustment. That is, the ECU 56 prepares to be able to extend the air springs 12 immediately when the second operation start information is acquired. Until the spring pressure of each of the air springs 12 reaches the vehicle height change start state, the ECU 56 continues to execute the preadjustment based on detection signals from the vehicle height sensors 58, the first pressure sensor 32a, the second pressure sensor 32b, and the like (S106: No).

In a case where the ECU 56 detects that the spring pressure of each of the air springs 12 reaches the vehicle height change start state, and the preadjustment is complete (S106: Yes), the ECU 56 confirms whether or not the second operation start information is acquired (S108). In a case where the ECU 56 acquires the second operation start information (S108: Yes), the ECU 56 executes adjustment of the vehicle height to the first vehicle height (the vehicle height H) (S110). That is, in order for the vehicle height of the vehicle 100 to reach the first vehicle height (the vehicle height H), the ECU 56 increases the spring pressure of each of the air springs 12 to the pressure required to realize the first vehicle height (the vehicle height H) by opening the vehicle height adjustment valves 14 so as to supply the working fluid from the pressure tank 26 to the air springs 12. Until the spring pressure of each of the air springs 12 reaches the pressure required to realize the first vehicle height (the vehicle height H), the ECU 56 continues to supply the working fluid based on detection signals from the vehicle height sensors 58, the first pressure sensor 32a, the second pressure sensor 32b, and the like. In a case where it is detected that the vehicle height reaches the first vehicle height (the vehicle height H), the air springs 12 maintain the first vehicle height (the vehicle height H) by closing the circuit valve block 24 or the vehicle height adjustment valves 14, and a series of vehicle height control is ended.

In a case where the second operation start information cannot be acquired in step S108 (S108: No), the process is ended, and step S100 and the subsequent steps are repeated. In a case where a user enters the first detection region 102, and a boarding operation does not occur yet, or in a case where boarding is stopped, the ECU 56 enters a standby state without executing vehicle height adjustment. That is, since the vehicle 100 continues to be stationary without any change in the position of the vehicle 100, the discomfort to the vicinity is suppressed. In this case, the spring pressure of the air springs 12 may be maintained.

In a case where the vehicle height of the vehicle 100 has already reached the first vehicle height (the vehicle height H) in step S102 (S102: Yes), vehicle height adjustment for boarding is not required, and thus, this process is ended. In a case where the ECU 56 is not capable of acquiring the first operation start information in step S100, the ECU 56 ends this process, and returns to a standby state to acquire the first operation start information.

As such, the vehicle height adjustment apparatus 10 in the embodiment increases the spring pressure of each of the air springs 12 to a vehicle height change start state in advance before acquiring a request to actually change the vehicle height (acquiring the second operation start information). In other words, in a case where a vehicle height change request is placed, it is possible to quickly change the vehicle height by dividing a vehicle height adjustment process into two stages, that is, preadjustment and main adjustment subsequent to the preadjustment, and reliably bringing the state of each of the air springs 12 into a vehicle height change start state. Accordingly, in a case where vehicle height adjustment is executed for boarding the vehicle 100, it is possible to quickly change the vehicle height at a proper timing. In a case where boarding of a user is complete, the ECU 56 executes control to return the vehicle height to a vehicle height suitable for travelling, that is, the vehicle height L. In a case where it is detected that a turn-on signal of a courtesy lamp (turned on when a door is opened) is eliminated, in a case where a device outputs signals, indicating that a user fastens a seat belt, or in a case where an ignition switch is turned on, the vehicle height is returned to the vehicle height suitable for travelling. That is, as illustrated in FIG. 4, the ECU 56 decreases the spring pressure of the air springs 12 and the vehicle height by pumping the working fluid from the air springs 12 to the pressure tank 26 via the compressor unit 30.

In step S106 of the flowchart illustrated in FIG. 8, the ECU 56 is in a standby state until preadjustment is complete. Since the amount of time required to complete the preadjustment is approximately 0.5 seconds, it is possible to reliably complete the preadjustment before acquiring the second operation start information by adjusting the set range of the first detection region 102. In another embodiment, in a case where step S106 is omitted, and the second operation start information is acquired regardless of whether or not the preadjustment is complete, the ECU 56 may immediately supply the working fluid to change the vehicle height to the first vehicle height (the vehicle height H). In this case, the preadjustment may not be complete, and in contrast, the working fluid is supplied prior to acquisition of the second operation start information, and thus, it is possible to reduce a delay time between time B and time A illustrated in FIG. 5. Accordingly, it is possible to reduce awkwardness associated with a delay in the vehicle height change.

In the sedan type vehicle 100 illustrated in the embodiment, the first vehicle height suitable for boarding is set to be higher than the second vehicle height suitable for parking. In an SUV typically having a high height, a vehicle height for boarding is desirably set to be low. That is, the first vehicle height is set to be lower than the second vehicle height, and control is executed so as to decrease the vehicle height when boarding. In addition, control is executed so as to increase the vehicle height such that the vehicle when parked has an improved appearance. The vehicle height adjustment apparatus 10 is capable of coping with a case where execution of the control is required, and the same effects can be obtained. In this case, in FIG. 6, the vehicle height H refers to the second vehicle height, and the vehicle height L refers to the first vehicle height. As illustrated in FIG. 6, since frictional resistance associated with the contraction operation of the air springs 12 is present in a case where the vehicle height is decreased, even if the spring pressure is decreased from P2 to P3, the vehicle height may not be immediately decreased. For this reason, also, in a case where the vehicle height is decreased for boarding, preadjustment is executed. That is, in FIG. 7, in a case where the portable terminal 104 enters the first detection region 102, as illustrated in FIG. 4, the ECU 56 decreases the spring pressure of each of the air springs 12 to a vehicle height change start state in advance by pumping the working fluid from the air springs 12 to the pressure tank 26 via the compressor unit 30. As a result, in a case where the portable terminal 104 enters the second detection region 108, the vehicle height can be decreased to the first vehicle height (the vehicle height L) immediately when a user operates a door handle. As such, also, in a case where the vehicle height is decreased for boarding, it is possible to quickly change the vehicle height when a vehicle height change request is placed. Accordingly, in a case where vehicle height adjustment is executed for boarding, it is possible to quickly change the vehicle height at a proper timing.

In the example illustrated in the embodiment, the vehicle height is changed for easy boarding the vehicle 100. Similarly, in a case where a user alights from the vehicle 100, the vehicle height may be changed for easy alighting the vehicle 100, and preadjustment technology of the vehicle height adjustment apparatus 10 in the embodiment can be adopted in this case. The ECU 56 is capable of using a shift signal, which indicates that a shift position is transitioned to a parking position, as the first operation start information required to execute preadjustment for alighting. In addition, any one of the following signals can be used: a signal indicating that the ignition switch is turned off, or is in a state similar to a turn-off state; a signal indicating that a user unfastens a seat belt; and a signal indicating alighting preparation. A turn-on signal of a courtesy lamp, which is turned on when a door is open, can be used as the second operation start information required to change the vehicle height. That is, it is possible to change the vehicle height immediately when a door handle is operated to open a door. As a result, the same effects as when boarding can be obtained.

In a case where a user completes alighting, the ECU 56 executes control to change the vehicle height to a vehicle height suitable for parking. For example, in a sedan type vehicle in which control is executed so as to increase the vehicle height when alighting, control is executed so as to change the vehicle height L. In contrast, in a vehicle, for example, an SUV in which control is executed so as to decrease the vehicle height when alighting, control is executed so as to change the vehicle height H. In a case where the ECU 56 detects a signal, which indicates that a door is locked, as an indication of the completion of alighting, or in a case where the ECU 56 detects elimination of a turn-on signal of a courtesy lamp as an indication of the completion of alighting, the ECU 56 changes the vehicle height to a vehicle height suitable for parking. Since the vehicle height may be changed to the vehicle height suitable for parking after a user moves away a certain distance from the vehicle, the ECU 56 may set a delay time between acquisition of a signal indicating the completion of alighting and the changing of the vehicle height.

In the example illustrated in the embodiment, in order to change the vehicle height when boarding, the spring pressure of each of the air springs 12 is adjusted to a vehicle height change start state by executing preadjustment in a case where the portable terminal 104 enters the first detection region 102. In another embodiment, the spring pressure of each of the air springs 12 may be adjusted to a vehicle height change start state when the vehicle is parked, and the vehicle height is changed to the first vehicle height suitable for parking. For example, in a case where the second vehicle height is set to be lower than the first vehicle height (for example, in a sedan type vehicle or a sport type vehicle), and the vehicle height is changed to the second vehicle height, first, the ECU 56 decreases the vehicle height to a third vehicle height set in advance which is lower than the second vehicle height (returns the working fluid to the pressure tank 26). Thereafter, the ECU 56 supplies the working fluid to the air springs 12 so as to increase the vehicle height from the third vehicle height to the second vehicle height, and stops the supply of the working fluid when a value indicating the second vehicle height is detected by the vehicle height sensors 58. That is, when the air springs 12 are stopped in the middle of extension, and the vehicle height is changed to the second vehicle height, preadjustment is executed. Accordingly, the air springs 12 are stopped when reach a vehicle height change start state, and the vehicle enters a parked state. Thereafter, in a case where supply of the working fluid is re-started when a user boards the parked vehicle, the air springs 12 can be immediately started to be increased (changed) from the vehicle height change start state.

Similarly, in a case where the second vehicle height is set to be higher than the first vehicle height (for example, in an SUV), and the vehicle height is changed to the second vehicle height, first, the ECU 56 increases the vehicle height to a third vehicle height set in advance which is higher than the second vehicle height (supplies the working fluid to the air springs 12). Thereafter, the ECU 56 returns the working fluid to the pressure tank 26 so as to decrease the vehicle height from the third vehicle height to the second vehicle height, and stops the discharge of the working fluid when a value indicating the second vehicle height is detected by the vehicle height sensors 58. That is, when the air springs 12 are stopped in the middle of extension, and the vehicle height is changed to the second vehicle height, preadjustment is executed. Accordingly, the air springs 12 are stopped when reach a vehicle height change start state, and the vehicle enters a parked state. Thereafter, in a case where discharge of the working fluid is restarted when a user boards the parked vehicle, the air springs 12 can be immediately started to be decreased (changed) from the vehicle height change start state.

As such, when the vehicle height is changed to the second vehicle height (during transition to a parked state), it is possible to omit a detection process or a preprocess for preadjustment in a case where a user is present in the first detection region 102 for boarding by adjusting the air springs 12 to the vehicle height change start state. In a case where a vehicle is parked for a long period of time, or in a case where a temperature change is severe during parking, a pressure state of the working fluid in the air springs 12 may be changed during parking. For example, in a case where a vehicle is parked in the daytime, and a user boards the vehicle in the night, or in a case where a vehicle is parked in the night, and a user boards the vehicle in the daytime, the working fluid may be contracted or expanded according to a change in an ambient temperature, and spring pressure may be changed. Accordingly, in a case where a predetermined condition, for example, one or more hours of parking or a temperature change of ±5° C. or greater, is satisfied during parking, when boarding, the ECU 56 may execute preadjustment via the first detection region 102, and execute control so as to adjust the air springs 12 to a vehicle height change start state. In this case, it is possible to accurately execute the preadjustment. In contrast, in a case where a parked state is maintained within one hour, or in a case where a temperature change is within ±5° C., the ECU 56 may execute preadjustment when the vehicle height is changed to the second vehicle height for parking, and may execute control so as to adjust the air springs 12 to a vehicle height change start state. In this case, a process for preadjustment when next boarding can be simplified.

The vehicle height adjustment apparatus 10 in the embodiment includes the four first opening and closing valve 24a, the second opening and closing valve 24b, the third opening and closing valve 24c, and the fourth opening and closing valve 24d, and switches the flow paths of the working fluid. As illustrated in FIGS. 1 to 4, relatively inexpensive two-port opening and closing valves with a simple configuration can be used as the first opening and closing valve 24a, the second opening and closing valve 24b, the third opening and closing valve 24c, and the fourth opening and closing valve 24d. As illustrated in FIGS. 2 to 4, the flow mode (flow path or flow direction) of the working fluid can be switched by changing the combination of the respective opening and closing states of the first opening and closing valve 24a, the second opening and closing valve 24b, the third opening and closing valve 24c, and the fourth opening and closing valve 24d, and cost can be reduced, or flow path design can be simplified.

In the example illustrated in the embodiment, in a case where vehicle height increasing control is executed, the ECU 56 selects at least one of the first flow path system, which is formed by opening the first opening and closing valve 24a and the fourth opening and closing valve 24d and the second flow path system which is formed by opening the second opening and closing valve 24b and the third opening and closing valve 24c. In another embodiment, in a case where vehicle height increasing control is executed, the ECU 56 may use both the first flow path system and the second flow path system at all times. In this case, ease of the flowing of the working fluid is improved, the vehicle height increasing speed is increased compared to a case where either one of the first flow path system or the second flow path system is selected, and thus, the vehicle height can be quickly adjusted. Selective control of the opening and closing valves of the circuit valve block 24 is not required during the vehicle height increasing control, and thus, a control logic becomes simplified.

In the example illustrated in the embodiment, in a case where vehicle height adjustment control (increasing control or decreasing control) is executed, the air springs 12 are extended or contracted at the same time. However, the air springs 12 may be individually adjusted by individually controlling the vehicle height adjustment valves 14. For example, in a case where supply of the working fluid is allowed by closing the rear wheel valve unit 18b,and opening the front wheel valve unit 18a, vehicle height adjustment only the front wheel side can be executed by the air springs 12FR and 12FL of the front wheels. Similarly, in a case where supply of the working fluid is allowed by closing the front wheel valve unit 18a, and opening the rear wheel valve unit 18b, vehicle height adjustment only on the rear wheel side can be executed by the air springs 12RR and 12RL of the rear wheels. In a case where supply of the working fluid is allowed by opening the vehicle height adjustment valves 14FR and 14RR, and closing the vehicle height adjustment valves 14FL and 14RL, vehicle height adjustment can be executed only by the air springs 12FR and 12RR of the right wheels. In contrast, in a case where supply of the working fluid is allowed by opening the vehicle height adjustment valves 14FL and 14RL, and closing the vehicle height adjustment valves 14FR and 14RR, vehicle height adjustment can be executed only by the air springs 12FL and 12RL of the left wheels. Also, in this case, since the vehicle height adjustment speed can be adjusted via selecting of the first flow path system and the second flow path system of the circuit valve block 24, it is possible to obtain the same effects as the case where vehicle height adjustment for the four wheels is executed at the same time.

In the embodiment, the vehicle height adjustment apparatus 10 equipped with a closed type working fluid supply and discharge system is described. In another embodiment, for example, this disclosure can also be applied to a vehicle height adjustment apparatus equipped with a so-called open type supply and discharge system which suctions the atmosphere (outside air), compresses the suctioned atmosphere via the compressor 36, and supplies the compressed suctioned atmosphere to the air springs 12 via the pressure tank 26. The same effects can be obtained. This disclosure can also be applied to a vehicle height adjustment apparatus equipped with an open type supply and discharge system including a compressor, a high-pressure tank, and a low-pressure tank. In this type, when vehicle height adjustment control is not executed, the compressor adjusts the pressure of the high-pressure tank or low-pressure tank to a predetermined value. In a case where supply and discharge of a working fluid is required, quick movement of the working fluid is realized due to the differential pressure between the pressure of the air springs 12 and the pressure of the high-pressure tank or low-pressure tank. That is, a pressure difference can always be formed between the tank and the air springs 12, smooth vehicle height control can be enabled, and the same effects as the other embodiment can be obtained.

A vehicle height adjustment apparatus according to an aspect of this disclosure includes: a plurality of vehicle height adjustment units that are respectively provided to correspond to wheels of a vehicle body, and change a vehicle height according to supply and discharge of a working fluid; a supply source of the working fluid; a plurality of opening and closing valves interposed between the vehicle height adjustment units and the supply source; and a control unit configured to control the vehicle height adjustment units so as to change the vehicle height to either one of a first vehicle height or a second vehicle height different from the first vehicle height. The control unit adjusts a working fluid supply and discharge state of each of the vehicle height adjustment units to a vehicle height change start state prior to changing the vehicle height from the second vehicle height to the first vehicle height. According to this configuration, the vehicle height adjustment units adjust the supply and discharge state of the working fluid to the vehicle height change start state prior to changing the vehicle height to the first vehicle height. As a result, it is possible to speed up a vehicle height adjustment operation by starting to change the vehicle height immediately when control to change the vehicle height to the first vehicle height is executed.

In the vehicle height adjustment apparatus according to the aspect, the first vehicle height may refer to a vehicle height suitable for boarding, and the second vehicle height may refer to a vehicle height suitable for parking. According to this configuration, it is possible to quickly change the vehicle height to the first vehicle height suitable for boarding.

In the vehicle height adjustment apparatus according to the aspect, the control unit may acquire first operation start information for executing preadjustment, and second operation start information for changing the vehicle height to the first vehicle height. According to this configuration, a vehicle height adjustment process is divided into two stages, that is, the preadjustment and a main adjustment subsequent to the preadjustment, and thus, it is possible to reliably bring the state of each of the vehicle height adjustment units into the vehicle height change start state.

In the vehicle height adjustment apparatus according to the aspect, the control unit may acquire information, which indicates that a user enters a first detection region centered around the vehicle body, as the first operation start information, and may acquire information, which indicates that the user enters a second detection region included in the first detection region, as the second operation start information. According to this configuration, in a case where the user merely approaches the vehicle, and enters the first detection region, a vehicle height change is not started. That is, only preparation to change the vehicle height is made. When the user enters the second detection region closer to the vehicle than the first detection region, the vehicle height change is started. That is, it is possible to start to change the vehicle height at a proper timing by detecting a case where the user is highly likely to board the vehicle.

In the vehicle height adjustment apparatus according to the aspect, the control unit may acquire the first operation start information in a case where a portable terminal held by the user is started to be present in the first detection region, and the control unit may acquire the second operation start information in a case where the user operates a door handle of the vehicle body. According to this configuration, in a case where it is detected that the user approaches the vehicle while holding a portable terminal for a smart entry system, the preadjustment is executed. A vehicle height change is started immediately when boarding is confirmed via operation of the door handle. As a result, it is possible to smoothly prepare a vehicle height change, and to change the vehicle height during a series of typical operations performed by the user between approach of the user to the vehicle and boarding the vehicle.

In the vehicle height adjustment apparatus according to the aspect, the control unit may consider a time when starting to change the vehicle height from the second vehicle height to the first vehicle height by acquiring vehicle height information indicating a change in the vehicle height and changing a supply and discharge state of the working fluid, as the vehicle height change start state. According to this configuration, in a case where a vehicle height change request is placed, it is possible to quickly start to change the vehicle height by easily and reliably adjusting the state of each of the vehicle height adjustment units to the vehicle height change start state.

In the vehicle height adjustment apparatus according to the aspect, the control unit may change the vehicle height to the first vehicle height or the second vehicle height, and execute the preadjustment based on the supplied and discharged amount of the working fluid. According to this configuration, it is possible to prepare and execute a vehicle height change only by controlling the supply and discharge of the working fluid.

The embodiment and the modification examples of this disclosure have been described; however, the embodiment and the modification examples are presented as examples, and are not intended to limit the scope of this disclosure. New embodiments can be realized in various forms, and various omissions, replacements, and changes can be made to this disclosure insofar as the omissions, the replacements, and the changes do not depart from the purport of this disclosure. The embodiment or modifications of the embodiment are included in the scope or the purport of this disclosure, and included in the appended claims and the equivalent range thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle height adjustment apparatus comprising:
a plurality of vehicle height adjustment units that are respectively provided to correspond to wheels of a vehicle body, and change a vehicle height according to supply and discharge of a working fluid;
a supply source of the working fluid;
a plurality of opening and closing valves interposed between the vehicle height adjustment units and the supply source; and
a control unit configured to control the vehicle height adjustment units so as to change the vehicle height to either one of a first vehicle height or a second vehicle height different from the first vehicle height,
wherein the control unit adjusts a working fluid supply and discharge state of each of the vehicle height adjustment units to a vehicle height change start state prior to changing the vehicle height from the second vehicle height to the first vehicle height.

2. The vehicle height adjustment apparatus according to claim 1,
wherein the first vehicle height refers to a vehicle height suitable for boarding, and the second vehicle height refers to a vehicle height suitable for parking.

3. The vehicle height adjustment apparatus according to claim 1,
wherein the control unit acquires first operation start information for executing the preadjustment, and second operation start information for changing the vehicle height to the first vehicle height.

4. The vehicle height adjustment apparatus according to claim 2,
wherein the control unit acquires first operation start information for executing the preadjustment, and second operation start information for changing the vehicle height to the first vehicle height.

5. The vehicle height adjustment apparatus according to claim 3,
wherein the control unit acquires information, which indicates that a user enters a first detection region centered around the vehicle body, as the first operation start information, and acquires information, which indicates that the user enters a second detection region included in the first detection region, as the second operation start information.

6. The vehicle height adjustment apparatus according to claim 4,
wherein the control unit acquires information, which indicates that a user enters a first detection region centered around the vehicle body, as the first operation start information, and acquires information, which indicates that the user enters a second detection region included in the first detection region, as the second operation start information.

7. The vehicle height adjustment apparatus according to claim 5,
wherein the control unit acquires the first operation start information in a case where a portable terminal held by the user is started to be present in the first detection region, and the control unit acquires the second operation start information in a case where the user operates a door handle of the vehicle body.

8. The vehicle height adjustment apparatus according to claim 6,
wherein the control unit acquires the first operation start information in a case where a portable terminal held by the user is started to be present in the first detection region, and the control unit acquires the second operation start information in a case where the user operates a door handle of the vehicle body.

9. The vehicle height adjustment apparatus according to claim 1,
wherein the control unit considers a time when starting to change the vehicle height from the second vehicle height to the first vehicle height by acquiring vehicle height information indicating a change in the vehicle height and changing a supply and discharge state of the working fluid, as the vehicle height change start state.

10. The vehicle height adjustment apparatus according to claim 2,
wherein the control unit considers a time when starting to change the vehicle height from the second vehicle height to the first vehicle height by acquiring vehicle height information indicating a change in the vehicle height and changing a supply and discharge state of the working fluid, as the vehicle height change start state.

11. The vehicle height adjustment apparatus according to claim 3,
wherein the control unit considers a time when starting to change the vehicle height from the second vehicle height to the first vehicle height by acquiring vehicle height information indicating a change in the vehicle height and changing a supply and discharge state of the working fluid, as the vehicle height change start state.

12. The vehicle height adjustment apparatus according to claim 5,
wherein the control unit considers a time when starting to change the vehicle height from the second vehicle height to the first vehicle height by acquiring vehicle height information indicating a change in the vehicle height and changing a supply and discharge state of the working fluid, as the vehicle height change start state.

13. The vehicle height adjustment apparatus according to claim 7,
wherein the control unit considers a time when starting to change the vehicle height from the second vehicle height to the first vehicle height by acquiring vehicle height information indicating a change in the vehicle height and changing a supply and discharge state of the working fluid, as the vehicle height change start state.

14. The vehicle height adjustment apparatus according to claim 1,
wherein the control unit changes the vehicle height to the first vehicle height or the second vehicle height, and executes the preadjustment based on the supplied and discharged amount of the working fluid.

15. The vehicle height adjustment apparatus according to claim 2,
wherein the control unit changes the vehicle height to the first vehicle height or the second vehicle height, and executes the preadjustment based on the supplied and discharged amount of the working fluid.

16. The vehicle height adjustment apparatus according to claim 3,
wherein the control unit changes the vehicle height to the first vehicle height or the second vehicle height, and executes the preadjustment based on the supplied and discharged amount of the working fluid.

17. The vehicle height adjustment apparatus according to claim 5,
wherein the control unit changes the vehicle height to the first vehicle height or the second vehicle height, and executes the preadjustment based on the supplied and discharged amount of the working fluid.

18. The vehicle height adjustment apparatus according to claim 7,
wherein the control unit changes the vehicle height to the first vehicle height or the second vehicle height, and executes the preadjustment based on the supplied and discharged amount of the working fluid.

19. The vehicle height adjustment apparatus according to claim 9,
wherein the control unit changes the vehicle height to the first vehicle height or the second vehicle height, and executes the preadjustment based on the supplied and discharged amount of the working fluid.
